(19) United States
(12) Patent Application Publication
(10) Pub. No.: US 2009/0215845 A1
(43) Pub. Date: Aug. 27, 2009

(54) Fungicidal mixtures

(76) Inventors: Rainer Bruns, Leverkusen (DE); Martin Kugler, Leichlingen (DE); Thomas Jaetsch, Köln (DE)

Correspondence Address: Nicanor A Kohncke;Lanxess Corporation, Law & Intellectual Property Department 111 RIDC, Park West Drive, Pittsburgh, PA, 15275-1112, US

(21) Appl. No.: 11/919,898

(22) PCT Filed: May 4, 2006
(86) PCT No.: PCT/EP2006/004158

§ 371 Date: Jan. 13, 2009

(30) Foreign Application Priority Data
May 13, 2005 (DE) 10 2005 022 148.3

(51) Int. Cl. A01N 43/653; A01P 3/00

(52) U.S. Cl. 514/383

(57) ABSTRACT

Synergistically effective mixtures comprising prochloraz and tebuconazole and fungicidal compositions based thereon are highly suitable for protecting industrial materials, in particular wood and timber products, against attack, damage and/or destruction by biological pests.

The present invention relates to novel synergistically effective mixtures comprising prochloraz and tebuconazole, to fungicidal compositions based on these mixtures and to the use of these mixtures and compositions for protecting industrial materials, in particular wood and timber products, against attack, damage and/or destruction by biological pests.

In principle, the person skilled in the art differentiates between a structural destruction of the wood by Basidiomycetes or by soft-rot fungi, if the wood is exposed to an environment of high humidity or even soil contact, and an optical impairment of the wood by wood-discolouring fungi.

Triazoles, such as, for example, tebuconazole (cf. EP-A 254857) and cyproconazole (cf. EP-A 554833) are already known for use in the protection of wood against wood-destroying Basidiomycetes and their activity in laboratory tests is very promising; however, in practice, they do not always ensure a sufficient protection of the wood, so that, in practical applications, these active compounds have to be combined with metals or metal salts, in particular copper salts. Thus in practice triazofungicides are frequently combined with compounds which comprise heavy metals such as, for example, copper compounds.

However, from an ecological point of view, the use of compositions for protecting wood which comprise heavy metals is to be considered to be objectionable. Accordingly, there is still a need for improved compositions for protecting wood, which compositions are based on active compounds which provide a satisfactory protection of wood without heavy metals being added.

The active compound prochloraz (N-propyl-N-[2-(2,4,6-trichlorophenoxy)ethyl]imidazole-1-carboxamide) (CAS No. 67747-09-5) is a known crop protection fungicide having a relatively broad activity spectrum.

By virtue of the action of prochloraz against Ascomycetes and Deuteromycetes, it has, on occasions (cf., for example, EP-A 1025967), been proposed to employ prochloraz for protection against wood-discolouring fungi; however, in practice, such an effectiveness has not been confirmed. In contrast, it is known that prochloraz is insufficiently active against blueing fungi (cf. J. A. Drysdale et al., New Zealand Journal of Forestry Science 1982, 12 (3), 457-466).

Furthermore, it has been described that mixtures of prochloraz with tri-n-butyltin compounds are suitable for protecting wood and industrial materials against attack by microorganisms (cf. DE-A 3522788). Furthermore, it is known that prochloraz can be used in combination with NOIT (2-N-octyl-3-isothiazolinone) for protection against wood-discolouring fungi (cf. NZ-A 331830). In both cases, based on the described unsatisfactory activity of prochloraz in the protection of wood, it has to be assumed that the action claimed is due essentially to the respective mixing partners. Although prochloraz is referred to in the abovementioned publications as a possible mixing partner for various active compounds for use in the protection of materials, it has to be stated that in practice, these mixtures do not play any role, owing to the unfavourable toxicological and ecotoxicological profile of the mixing partners and/or the unsatisfactory action of prochloraz mentioned.

Surprisingly, it has been found that the combination of prochloraz, which on its own has insufficient activity, with tebuconazole acts synergistically both against wood-destroying Basidiomycetes and against soft-rot fungi, i.e. the fungicidal effectiveness of the synergistic mixtures is, in an unexpected manner, higher than the sum of the fungicidal activities of the respective fungicides on their own.

The synergistically enhanced activity has the additional advantage that, owing to the lower amount of fungicide to be used in a wood protection composition in accordance with the present invention, not only an economical advantage is obtained, but the safety risk to the environment is also reduced.

Accordingly, the present invention provides fungicidal mixtures comprising a synergistically effective amount of prochloraz and tebuconazole.

The weight ratios of the active compounds in the active compound mixture may be varied within a relatively wide range. Preference is given to weight ratios of tebuconazole to prochloraz in the range from 1:99 to 99:1, particularly preferably from 1:20 to 20:1.

Especially preferred are active compound mixtures which comprise prochloraz and tebuconazole in a weight ratio of from 9:1 to 1:9.

The synergistic mixtures claimed are suitable for controlling biological pests. In particular, the mixtures according to the invention have a particularly high microbicidal, in particular fungicidal, action, combined with a broad activity spectrum against microorganisms which are of relevance in the protection of materials. They are active in particular against wood-destroying Basidiomycetes and soft-rot fungi.

The following microorganisms may be mentioned by way of example, but not by way of limitation:

Chaetomium globosum, Glenospora graphii, Humicola gisea, Petriella setifera, Trichurus spiralis and Lecythophora mutabilis and also against Trichoderma viride, Stachybotrys cartarum, Chephalosporium sp. and Acremonium sp.

Coniophora puteana, Coriolus versicolor, Gloeophyllum abietinum, Gloeophyllum trabeum, Lentinus tigrinus, Poria monticola, Poria placenta, Serpula lacrymans, Stereum sanguinolentum, Tyromyces palustris.

In addition to wood-destroying Basidiomycetes and soft-rot fungi, in the protection of wood, wood-discolouring fungi and harmful insects, too, play a role. In addition to soft-rot fungi, bacteria such as, for example, Caldocellulosiruptor sp., Anaerocellum sp., Clostridium species, such as Clostridium cellulovorans, Clostridium aldrichii, Cellulomonas species, Streptomycetes, Micromonospora sp., Thermomonospora sp., Microbispora sp. and Cytophaga und Sporocytophaga species may also contribute decisively to the degradation of cellulose under humid conditions.

To broaden the activity spectrum or to obtain particular effects, the synergistic mixtures according to the invention can be combined with at least one further microbicidally active compound. In particular, the synergistic mixture may comprise at least one further active compound from the group of the fungicides, in particular blueing fungicides, insecticides and antibacterially active compounds.

Preference is given in particular to combinations of the mixtures according to the invention with one or more of the following fungicidal components: dichlofluanid, tolylfluanid, carbendazim, fenpropimorph, bethoxazin, thiocyanato-methylthiobenzothiazole, 3-iodo-2-propynyl n-butyl-carbamate, zinc pyrithione, copper pyrithione, N-(3-aminopropyl)-N-dodecylpropane-1,3-diamine.

Especially preferred are combinations of the mixtures according to the invention with one or more of the following fungicidal components: dichlofluanid, tolylfluanid, bethoxazin, 3-iodo-2-propynyl butylcarbamate, zinc pyrithione and copper pyrithione.

Preference is likewise given to combinations of the mixtures according to the invention with one or more of the following insecticidal and termiticidal components:

acetamiprid, allethrin, alpha-cypermethrin, beta-cyfluthrin, bifenthrin, bioallethrin, 4-chloro-2-(2-chloro-2-methylpropyl)-5-[(6-iodo-3-pyridinyl)methoxy]-3(2H)-pyridazinone (CAS-RN: 120955-77-3), chlorfenapyr, chlorpyrifos, clothianidin, cyfluthrin, cyhalothrin, cypermethrin, deltamethrin, etofenprox, fenoxycarb, fipronil, flufenoxuron, hexaflumuron, imidacloprid, nitenpyram, permethrin, pyriproxifen, silafluofen, tebufenozide, thiacloprid, thiamethoxam, tralomethrin, triflumuron.

Particular preference is given to combinations of the mixtures according to the invention with one or more of the following termiticides:

bifenthrin, chlorfenapyr, clothianidin, cyfluthrin, cypermethrin, deltamethrin, etofenprox, imidacloprid, permethrin, thiacloprid, thiamethoxam.

Especially preferred are combinations of the mixtures according to the invention with one or more of the following termiticides:

bifenthrin, clothianidin, imidacloprid, permethrin, thiacloprid.

Preference is likewise given to combinations of the mixtures according to the invention with one or more of the following bactericidal components:

benzyl alcohol mono-(poly)-hemiformal, ethylene glycol hemiformal, N-(2-hydroxypropyl)aminomethanol, N-methylisothiazolin-3-one, 5-chloro-N-methylisothiazolin-3-one, 4,5-benzisothiazolinone, formaldehyde, glutaraldehyde, benzalkonium chloride, benzyldimethyltetradecylammonium chloride, benzyldimethyldodecylammonium chloride, 3-methyl-4-chlorophenol and also 2-benzyl-4-chlorophenol and their alkali metal and alkaline earth metal salts, p-hydroxybenzoic esters and also o-phenylphenol and their alkali metal and alkaline earth metal salts, bronopol, 2,2-dibromo-3-nitrilepropionamide and silver compounds.

Preference is given to combinations of the mixtures according to the invention with one or more of the following bactericides:

benzyl alcohol mono-(poly)-hemiformal, N-methylisothiazolin-3-one, 5-chloro-N-methylisothiazolin-3-one, 4,5-benzisothiazolinone, glutaraldehyde, benzalkonium chloride, bronopol, 3-methyl-4-chlorophenol and also 2-benzyl-4-chlorophenol and the alkali metal and alkaline earth metal salts, o-phenylphenol and their alkali metal and alkaline earth metal salts and silver compounds.

Very particular preference is given to combinations of the mixtures according to the invention with one or more of the following bactericides:

benzyl alcohol mono-(poly)-hemiformal, 4,5-benzisothiazolinone, benzalkonium chloride, bronopol, 3-methyl-4-chlorophenol and also 2-benzyl-4-chlorophenol and their sodium and potassium salts, o-phenylphenol and the sodium and potassium salts and silver(I) compounds.

The mixtures according to the invention generally comprise 0.01-85 per cent by weight of prochloraz, 0.01-85 per cent by weight of tebuconazole and, if appropriate, 0.05-80 per cent by weight of at least one further microbicidally active compound, in particular from the group of the fungicides, insecticides, termiticides and bactericides mentioned above.

Preferably, the mixtures according to the invention comprise 0.1-40 per cent by weight of prochloraz, 0.1-40 per cent by weight of tebuconazole and, if appropriate, 0.1-30 per cent by weight of at least one further microbicidally active compound, in particular from the group of the active compounds mentioned above.

The mixtures according to the invention can be prepared in a known manner, for example by grinding and/or mixing and/or granulating the active compounds in a suitable apparatus. It is also possible to dissolve, to disperse or to emulsify the active compounds individually or together in a suitable solvent, if appropriate with addition of further auxiliaries and additives, such as, for example, emulsifiers, and, if appropriate, to precipitate them from this solvent by adding a further solvent or, if appropriate, removing the solvent to dryness by distillation. Both the individual active compounds used for preparing the mixtures according to the invention and the finished active compound mixtures can, depending on their respective physical and/or chemical properties, be converted into the customary formulations, such as solutions, emulsions, suspensions, powders, foams, pastes, granules, aerosols and microencapsulations in polymeric substances.

The present invention furthermore provides the use of the active compound mixtures according to the invention for protecting industrial materials, in particular wood, timber products and wood/plastic composites, against attack, damage and/or destruction by biological pests, in particular by wood-destroying Basidiomycetes and soft-rot fungi.

The present invention furthermore provides microbicidal compositions comprising a synergistically effective amount of prochloraz and tebuconazole and also at least one diluent or solvent, if appropriate further auxiliaries and additives and also, if appropriate, at least one further active compound mentioned.

The formulations are prepared in a known manner, for example by mixing the active compounds with extenders, i.e. liquid solvents, pressurized liquefied gases and/or solid carriers, if appropriate with the use of surfactants, i.e. emulsifiers and/or dispersants and/or foam formers. If the extender used is water, it is also possible to employ, for example, organic solvents as auxiliary solvents. Suitable liquid solvents are essentially: aromatic compounds, such as xylene, toluene or alkylnaphthalenes, aliphatic hydrocarbons, such as cyclohexane or paraffins, for example mineral oil fractions, alcohols, such as butanol or glycol, and also ethers and esters thereof, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers are to be understood as meaning liquids which are gaseous at ambient temperature and under atmospheric pressure, for example aerosol propellants, such as halogenated hydrocarbons, and also butane, propane, nitrogen and carbon dioxide. Suitable solid carriers are: for example natural ground minerals, such as kaolins, clays, talc, chalk, quartz, attapulgite, montmorillonite or diatomaceous earth, and ground synthetic minerals, such as finely divided silica, alumina and silicates. Suitable solid carriers for granules are: for example crushed and fractionated natural minerals, such as calcite, marble, pumice, sepiolite, dolomite, and also synthetic granules of inorganic and organic meals and also granules of organic material, such as sawdust, coconut shells, corn cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates. Suitable dispersants are: for example lignosulphite waste liquors and methylcellulose.

Tackifiers, such as carboxymethylcellulose and natural and synthetic polymers in the form of powders, granules and latices, such as gum arabic, polyvinyl alcohol and polyvinyl acetate, or else natural phospholipids, such as cephalins and lecithins and synthetic phospholipids can be used in the formulations. Other possible additives are mineral and vegetable oils.

It is possible to use colorants such as inorganic pigments, for example iron oxide, titanium oxide and Prussian blue, and organic dyes, such as alizarin dyes, azo dyes and metal phthalocyanine dyes, and trace nutrients, such as salts of iron, manganese, boron, copper, cobalt, molybdenum and zinc.

The formulations generally comprise between 0.1 and 95 per cent by weight of active compound combination, preferably between 0.5 and 50 per cent by weight.

The microbicidal compositions or concentrates used for protecting the industrial materials comprise the active compound or the active compound combination in a concentration of from 0.005 to 95 per cent by weight, in particular from 0.1 to 50 per cent by weight.

The application concentrations of the active compounds or the active compound combinations to be used depend on the nature and the occurrence of the microorganisms to be controlled and on the composition of the material to be protected. The optimum amount to be employed can be determined by test series. In general, the application concentrations are in the range of from 0.001 to 10 per cent by weight, preferably from 0.01 to 5 per cent by weight, based on the material to be protected.

By using the active compound combinations or compositions according to the invention, it is possible to replace, in an advantageous manner, the microbicidal compositions hitherto available by more effective compositions. The compositions according to the invention have good stability and, in an advantageous manner, a broad activity spectrum.

Wood, timber products and wood/plastic composites which can be protected by the active compound mixtures according to the invention or the compositions comprising them are, by way of example: construction timber, wooden beams, railway sleepers, bridge components, jetties, vehicles made of wood, boxes, palettes, containers, telephone poles, wood lagging, windows and doors made of wood, ply wood, medium density fibre board (MDF), chip board, oriented strand board (OSB), waferboard, laminated veneer lumber (LVL) or timber products which, quite generally, are used in the construction of houses or building joinery, and also wood/plastic composites.

The active compounds can be applied individually or as a finished mixture, in the form of their formulations or the use forms prepared therefrom, such as ready-to-use solutions, suspensions, pastes, soluble powders. Application is in a customary manner by treating the industrial material with the individual active compounds or the finished mixture or with a formulation or use form prepared therefrom. If the materials to be protected are wood, timber products or wood/plastic composites, the application is by customary methods, for example by spraying, painting, dipping, industrial impregnation processes, for example vacuum, double vacuum or pressure processes, and by addition to the glue or by addition via the compounder or mixer, and also via masterbatches.

A particularly effective protection of wood is achieved by industrial impregnation processes, for example by vacuum, double vacuum or pressure processes.

The present invention furthermore provides a method for protecting wood and timber products, where the wood or the timber product is impregnated with a synergistically effective amount of prochloraz and tebuconazole and at least one diluent or solvent, if appropriate further auxiliaries and additives and also, if appropriate, at least one further active compound mentioned, by painting, spraying, vacuum, double vacuum, pressure or dipping processes. Here, the active compounds prochloraz and tebuconazole can be employed either individually or as a finished mixture.

### BIOLOGICAL EXAMPLES

The synergism was then determined using the method described by Kull et al. (F. C. Kull, P. C. Eismann, H. D. Sylvestrowicz, R. L. Mayer, Applied Microbiology 9, 538 to 541, 1961). Here, the following relationships apply:

QA/Qa+QB/Qb=SI

Qa=concentration of substance A which corresponds to the MIC

Qb=concentration of substance B which corresponds to the MIC

QA=concentration of substance A in the concentration of A/B which suppresses microbial growth

QB=concentration of substance B in the concentration of A/B which suppresses microbial growth

SI=synergistic index

SI=1 means the activities are additive

SI>1 means antagonism

SI<1 means synergism

### Example 1

Various concentrations of prochloraz (A), tebuconazole (B) and mixtures of the two active compounds mentioned (AB) were tested against the soft-rot pathogen Trichurus spiralis on nutrient agar media. The minimum inhibitory concentration (MIC) refers to the value of the active compound or the active compound mixture in question where no growth could be observed.

| Active | | MIC | |
|---|---|---|---|
| compound | Mixing ratio | [ppm] | SI |
| A | | 5 | |
| A:B | 9:1 | 5 | 0.9 |
| A:B | 8:2 | 5 | 0.8 |
| A:B | 7:3 | 5 | 0.7 |
| A:B | 3:2 | 5 | 0.61 |
| A:B | 1:1 | 5 | 0.51 |
| A:B | 2:3 | 5 | 0.42 |
| A:B | 3:7 | 5 | 0.32 |
| A:B | 1:4 | 5 | 0.22 |
| B | | 200 | |

From the index data determined it is evident, that the combination according to the invention of prochloraz and tebuconazole shows a pronounced synergism against soft rot over a wide range.

### Example 2

Various concentrations of prochloraz (A), tebuconazole (B) and mixtures (AB) of the two active compounds mentioned were tested against the wood-destroying Basidiomycetes Coriolus versicolor. Mycelium pieces were punched out of a colony of the wood-destroying organism and incubated at 26° C. on a nutrient agar which contained malt extract peptone. The radial growth of the hypha with and without added active compound was then compared. The minimum inhibitory concentration (MIC) stated below is the lowest concentration of active compound at which the radial growth is suppressed completely.

| Active | | MIC | |
|---|---|---|---|
| compound | Mixing ratio | [ppm] | SI |
| A | | 6 | |
| A:B | 9:1 | 0.5 | 0.24 |
| A:B | 8:2 | 0.3 | 0.24 |
| A:B | 7:3 | 0.3 | 0.33 |
| A:B | 3:2 | 0.3 | 0.43 |
| A:B | 1:1 | 0.3 | 0.53 |
| A:B | 2:3 | 0.3 | 0.62 |
| A:B | 3:7 | 0.3 | 0.71 |
| A:B | 1:4 | 0.3 | 0.81 |
| A:B | 1:9 | 0.3 | 0.91 |
| B | | 0.3 | |

From the index data determined it is evident, that the combination according to the invention of prochloraz and tebuconazole shows a pronounced synergism against the wood-destroying Basidiomycetes Coriolus versicolor over a wide range.

### Example 3

Untreated cotton sailcloth consisting of cellulose (500 g/m²) was drenched with a solution of 800 ppm of prochloraz (A) and 800 ppm of tebuconazole (B) and a mixture (AB) comprising 200 ppm of prochloraz and 200 ppm of tebuconazole in ethanol. The samples were dried at 23° C. and 50% relative atmospheric humidity for 7 days and incorporated into biologically active soil according to DIN ENV 807. After 4 weeks, tear resistance of the cotton cloth was determined as a measure for the protection against destruction by microorganisms achieved by the active compounds.

Sample A, treated with 800 ppm of prochloraz, and sample B, treated with 800 ppm of tebuconazole, were each easy to tear, whereas sample C, treated with a mixture of 200 ppm of prochloraz and 200 ppm of tebuconazole, was difficult to tear.

This result shows that the combination according to the invention of prochloraz and tebuconazole has a clear activity-enhancing effect and can be used for protecting materials which comprise cellulose.

### FORMULATION EXAMPLES

### Example 1

### Technical-Grade Concentrate

10% of prochloraz, 10% of tebuconazole, 9% of sodium rhizinolate/sodium dodecylbenzene sulphonate preparation, 25% of ethoxylated castor oil, 46% of texanol

### Example 2

### Emulsifiable Concentrate

2.5% of tebuconazole, 2.5% of prochloraz, 3% of sodium rhizinolate/sodium dodecylbenzene sulphonate preparation, 27% of fatty acid polyethylene glycol ether ester, 65% of texanol

1. Mixtures, comprising a synergistically effective amount of the active compounds prochloraz (N-propyl-N-[2-(2,4,6-trichlorophenoxy)ethyl]imidazole-1-carboxamide) and tebuconazole ((+)-alpha-[2-(4-chlorophenyl)ethyl]-.alpha.-(1,1-dimethylethyl)-1H-1,2,4-triazole-1-ethanol).

2. Mixture according to claim 1, characterized in that the weight ratio of prochloraz to tebuconazole is from 1:99 to 99:1.

3. Mixture according to at least one of claims 1 and 2, characterized in that it comprises at least one further microbicidally active compound from the group of the fungicides, insecticides, termiticides and antibacterially active compounds.

4. Mixture according to at least one of claims 1 to 3, characterized in that it comprises, as microbicidally active compound, at least one compound from the group consisting of dichlofluanid, tolylfluanid, bethoxazin, 3-iodo-2-propynyl butylcarbamate, zinc pyrithione or copper pyrithione, bifenthrin, chlorfenapyr, clothianidin, cyfluthrin, cypermethrin, deltamethrin, etofenprox, imidacloprid, permethrin, thiacloprid, thiamethoxam, benzyl alcohol mono-(poly)-hemiformal, 4,5-benzisothiazolinone, benzalkonium chloride, bronopol, 3-methyl-4-chlorophenol and 2-benzyl-4-chlorophenol and their sodium and potassium salts, o-phenylphenol and the sodium and potassium salts and silver(I).

5. Mixture according to at least one of claims 1 to 4, characterized in that it comprises 0.01-85 per cent by weight of prochloraz, 0.01-85 per cent by weight of tebuconazole and, if appropriate, 0.05-80 per cent by weight of at least one further microbicidally active compound from the group of the fungicides, insecticides, termiticides and antibacterially active compounds.

6. Process for preparing a mixture according to at least one of claims 1 to 5, characterized in that a synergistically effective amount of the active compounds prochloraz and tebuconazole and, if appropriate, further microbicidally active compounds from the group of the fungicides, insecticides, termiticides and antibacterially active compounds and, if appropriate, auxiliaries and additives are mixed, ground, granulated, emulsified or dispersed in a suitable apparatus.

7. Microbicidal composition for protecting industrial materials, which composition comprises a mixture according to at least one of claims 1 to 5 and at least one solvent or diluent and, if appropriate, processing auxiliaries and, if appropriate, further antimicrobially active compounds.

8. Use of a mixture according to at least one of claims 1 to 5 or of a composition according to claim 7 for protecting industrial materials against attack and destruction by biological pests.

9. Use according to claim 8, characterized in that the industrial materials are wood, timber products and wood/plastic composites.

10. Method for protecting wood and timber products and wood/plastic composites against attack and destruction by biological pests, characterized in that the wood or the timber product or the wood/plastic composite is impregnated with a synergistically effective amount of prochloraz and tebuconazole and at least one diluent or solvent, if appropriate further auxiliaries and additives and also, if appropriate, at least one further biocidally active compound, by painting, spraying, vacuum, double vacuum, pressure or dipping processes or by addition to the glue or by addition via the compounder or mixer and also via masterbatches.

11. Industrial materials, comprising a mixture according to at least one of claims 1 to 5.
